(19) United States
(12) Patent Application Publication
(10) Pub. No.: US 2003/0008213 A1
(43) Pub. Date: Jan. 9, 2003

(54) Method for manufacturing lithium battery

(75) Inventor: Kyu-Woong Cho, Gwangmyung-city (KR)

Correspondence Address: LEYDIG VOIT & MAYER, LTD, 700 THIRTEENTH ST. NW, SUITE 300, WASHINGTON, DC, 20005-3960, US

(73) Assignee: Samsung SDI Co., Ltd., Suwon-city (TW)

(21) Appl. No.: 10/153,223

(22) Filed: May 23, 2002

(30) Foreign Application Priority Data
May 23, 2001 (KR) 01-28481

(51) Int. Cl. H01M 4/58; H01M 4/04

(52) U.S. Cl. 429/231.95; 29/623.1; 205/59

(57) ABSTRACT

Provided is a method of preparing a battery employing a high-temperature formation method, a room-temperature formation method after storage at a high temperature or a compressive formation method with application of external pressure. The problem of swelling often occurring at a high temperature and at room temperature can be notably improved while minimizing a recovery ratio of the standard capacity of the battery.

### BACKGROUND OF THE INVENTION

1. Field of the Invention

The present invention relates to a method for manufacturing a lithium battery, and more particularly, to a method for manufacturing a lithium battery which can notably improve a swelling problem at a high temperature and room temperature.

2. Description of the Related Art

According to the advancement of portable electronic devices such as cellular phones, notebook type computers, camcorders and the like, secondary batteries capable of charging and discharging are under vigorous research and development as power sources for such devices. Such secondary batteries are classified into batteries of various types, including nickel-cadmium batteries, lead storage batteries, nickel-hydrogen batteries, lithium ion batteries, lithium ion polymer batteries, air-zinc storage batteries and so on. In particular, the lithium secondary batteries, such as lithium ion batteries and lithium ion polymer batteries, have approximately 3 times of a long-lasting lifetime, and a high energy density per unit volume, compared to the Ni-Cd batteries or Ni-H batteries which are widely used as power sources of electronic devices. Thus, the lithium secondary batteries have attracted particular attention because of such excellent characteristics.

Lithium secondary batteries are classified according to the kind of electrolyte used, i.e., into liquid electrolyte batteries and polymer electrolyte batteries. In general, the batteries using liquid electrolyte are referred to as lithium ion batteries, and batteries using polymer electrolyte are referred to as lithium ion polymer batteries.

A lithium secondary battery is generally manufactured as follows. First, a slurry, prepared by mixing an active material for each electrode, including a binder and a plasticizer, is coated on a positive electrode current collector and a negative electrode current collector, respectively, to form a positive electrode plate and a negative electrode plate. The positive and negative electrode plates are stacked on both sides of a separator to form a battery cell having a predetermined shape, and then the battery cell is housed in a battery case, thereby completing a battery pack.

In general, a lithium ion polymer battery is manufactured by preparing a battery cell, subjecting the battery cell to a formation process for activating the completed battery cell by repeating charging and discharging cycles with a low current, followed by a degassing process, and finally thermally fusing.

In order to avoid deterioration in battery performance, e.g., accelerated decomposition of electrolyte solution or decreased charging/discharging capacity at a high temperature, it is common that lithium ion polymer batteries are not exposed to high-temperature conditions. Thus, manufacturing lithium ion batteries is basically performed at room temperature, and a formation process thereof is also performed at room temperature.

In the meantime, high-temperature aging, for example, aging a lithium battery at 40 to 50° C. for 3 to 7 days and then storing the same at room temperature of 15 to 25° C. for 1 day, or aging at 40 to 60° C., can advantageously reduce the time necessary for aging to allow an electrolyte solution to be evenly impregnated into electrode plates after injection of the electrolyte solution into the battery pack. However, this technology still has disadvantages including swelling of a battery exposed to a high temperature, leakage of an electrolyte solution, deterioration in battery performance and so on.

It is generally known that swelling a lithium ion polymer battery, occurring when it is exposed to a high temperature, is attributed to activated reactions between active materials and an electrolyte solvent at a high temperature, increased vapor pressure of an electrolyte solvent itself at a high temperature, moisture contained in the battery, and so on.

### SUMMARY OF THE INVENTION

To solve the above problems, it is an object of the present invention to provide a high-temperature formation method of a lithium battery, by which battery performance can be notably improved while considerably reducing swelling of the battery.

It is another object of the present invention to provide a room-temperature formation method in manufacturing a lithium battery, in which gas generation is promoted by storing the battery at a high temperature prior to formation, primary degassing is performed and a room-temperature formation process is then performed, by which battery performance can be notably improved while considerably reducing swelling of the battery.

It is another object of the present invention to provide a compressive formation method in manufacturing a lithium battery, which is performed while applying external pressure to the battery.

To achieve the above objects, in a first aspect of the present invention, there is provided a method for manufacturing a lithium battery including forming a battery cell having a predetermined shape by preparing a positive electrode plate and a negative electrode plate by coating a positive electrode current collector and a negative electrode current collector each with a composition containing an active material and a binder, respectively, and disposing the positive and negative electrode plates on both sides of a separator, inserting the battery cell into a battery case, and subjecting the resultant structure to a high-temperature formation process.

Preferably, the high-temperature formation process is performed at a temperature of approximately 35° C. to approximately 90° C.

Also, the high-temperature formation process is preferably performed while applying external pressure to the resultant structure.

The method may further include the degassing process of removing the gas generated in the resultant structure after the high-temperature formation process.

According to another aspect of the present invention, there is provide a method for manufacturing a lithium battery including forming a battery cell having a predetermined shape by preparing a positive electrode plate and a negative electrode plate by coating a positive electrode current collector and a negative electrode current collector each with a composition containing an active material and a binder, respectively, and disposing the positive and negative electrode plates on both sides of a separator, inserting the battery cell into a battery case, storing the resultant structure at a high temperature for a predetermined time, and subjecting the resultant structure to a room-temperature formation process.

Preferably, the high-temperature storage process is performed at a temperature of approximately 35° C. to approximately 90° C.

Also, a time for the high-temperature storage process is preferably in the range of approximately 5 minutes to approximately 4 hours.

The room-temperature formation process is preferably performed while applying external pressure to the resultant structure.

Between the high-temperature storage process and the room-temperature formation process, the degassing process of removing the gas generated in the resultant structure may be further provided.

According to still another aspect of the present invention, there is provided a method for manufacturing a lithium battery including forming a battery cell having a predetermined shape by preparing a positive electrode plate and a negative electrode plate by coating a positive electrode current collector and a negative electrode current collector each with a composition containing an active material and a binder, respectively, and disposing the positive and negative electrode plates on both sides of a separator, inserting the battery cell into a battery case, and subjecting the resultant structure to a compressive formation process while applying external pressure to the resultant structure.

The external pressure applied in the compressive formation process is preferably in the range of 10 to 5000 g/cm².

Preferably, the compressive formation process is performed at room temperature.

In the method for manufacturing a lithium battery, an electrolyte of the battery may include a lithium salt.

### BRIEF DESCRIPTION OF THE DRAWINGS

The above objects and advantages of the present invention will become more apparent by describing in detail preferred embodiments thereof with reference to the attached drawing in which:

FIG. 1 is a graphical representation of swelling data of lithium batteries having various solvents in an electrolyte solution and stored at 85° C. for more than 4 hours, the swelling data measured at regular intervals.

### DESCRIPTION OF THE PREFERRED EMBODIMENT

The feature of a method for manufacturing a lithium battery using an electrolyte containing a lithium salt, according to a first aspect of the present invention, lies in that the lithium battery is subjected to a high-temperature formation process.

In a first aspect of the present invention, a battery cell undergoes a formation process at a high temperature through repeated charging/discharging cycles with a small current and the gas generated in the battery cell is then removed during a subsequent degassing process, thereby solving the problem of swelling of the battery, the swelling occurring in the case where the battery is stored under a high-temperature condition like in the conventional technology. That is to say, various reactions that may undesirably occur under high-temperature conditions, take place prematurely during a high-temperature formation process by design, and byproducts generated by the reactions can be removed by degassing.

Conventionally, performing such a formation process at high temperatures has been restricted because there is a possibility of lowering battery performance. According to the present invention, it has been found that performing a formation process at an appropriate temperature can overcome the problem of battery swelling at high temperatures while minimizing deterioration in battery performance, e.g., accelerated decomposition of an electrolyte solution at high temperatures or a decrease in charge/discharge capacity of a lithium ion battery.

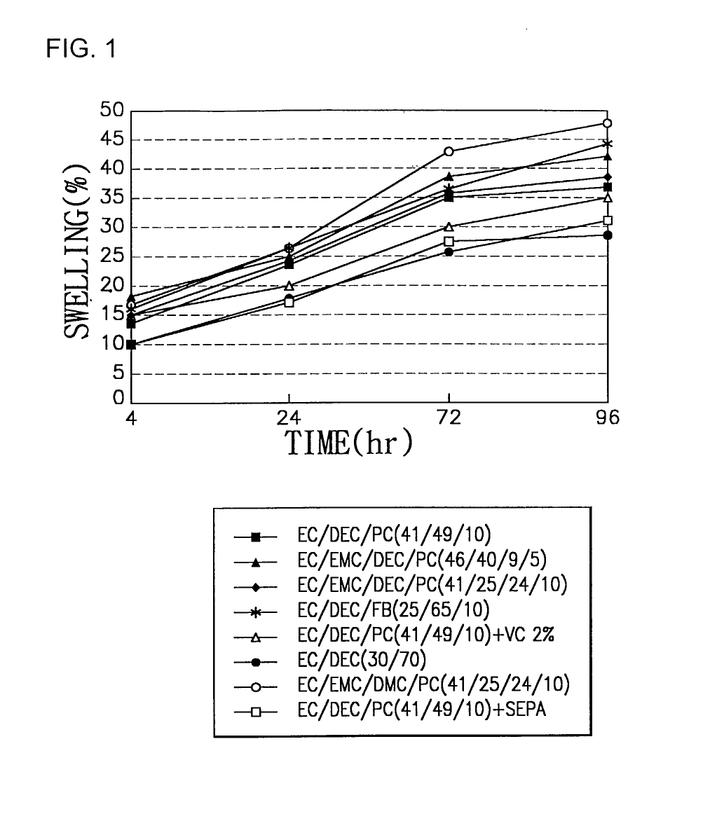

Under the high-temperature conditions, a preferred temperature is in the range of 35 to 90° C. If the temperature exceeds 90° C., a battery may disadvantageously undergo excessive swelling when stored for more than 4 hours at higher than 90° C., as shown in FIG. 1. FIG. 1 is a graphical representation of swelling data of lithium batteries having various solvents in an electrolyte solution and stored at 85° C. for more than 4 hours, the swelling data measured at regular intervals. Referring to FIG. 1, in the case of using a mixed solvent of ethylene carbonate (EC)/diethyl carbonate (DEC) being in the ratio of 30:70 (by weight), the lowest extent of swelling of approximately 10% is exhibited, while the highest extent of swelling of approximately 19% in the case of using a mixed solvent of EC/ethylmethyl carbonate (EMC)/dimethyl carbonate (DMC)/propylene carbonate (PC) being in the ratio of 41:25:24:10. In FIG. 1, “FB” denotes fluorobenzene, “VC” denotes vinylene carbonate, and “SEPA” in the plot indicated by -□- denotes a separator extended to wind up the surface of a jelly-roll type battery for suppressing swelling. Excessive swelling of a lithium battery gives rise to difficulty in electrochemical migration of lithium ions, resulting in lowering of charge/discharge efficiency. In some cases, a high-temperature formation process can be performed with external pressure applied to a battery pack, advantageously leading to a decrease in a capacity reduction ratio during charge/discharge cycling.

A method for manufacturing a lithium battery according to a second aspect of the present invention features that a battery pack is stored at a high temperature for a predetermined period of time and is then subjected to a room-temperature formation process.

The storage temperature is preferably in the range of approximately 35 to 90° C. for the reasons stated above. The high-temperature storage time is preferably in the range of approximately 5 minutes to approximately 4 hours, as shown in FIG. 1. The lower limit of the storage time is typically 5 minutes but is not limited thereto. However, if the storage time is longer than 4 hours, more than 10% of swelling of a battery occurs, resulting in deterioration of battery performance in view of capacity and lifetime.

According to the second aspect of the present invention, even if a battery is subjected to a room-temperature formation process after storage at a high temperature for a constant time, a reduction in capacity of the battery due to high-temperature exposure can be minimized while notably suppressing swelling of the battery. This is because various reactions that may undesirably occur under high-temperature conditions, take place prematurely during a high-temperature formation process by design, and byproducts generated by the reactions can be removed by degassing.

Alternatively, the room-temperature formation process, preceded by exposing at a high temperature, can be performed while external pressure is applied to a battery, which is advantageous in that the degassing is efficiently performed in consequence of a decrease in capacity reduction ratio during charge/discharge cycling.

Preferably, a degassing process for removing the gas generated in a battery pack during high-temperature storage may be performed between the high-temperature storage process and the room-temperature formation process.

A method for manufacturing a lithium battery according to a third aspect of the present invention features that a compressive formation process is performed while applying external pressure to the battery in manufacturing a lithium battery employing an electrolyte with a lithium salt.

Here, the externally applied pressure is preferably in the range of 10 to 5000 g/cm². If the pressure is less than 10 g/cm², the shortage entails the disadvantage that adhesion of electrodes is not sufficient, and it leads to a decrease in capacity during charge/discharge cycling. If the pressure exceeds 5000 g/cm², the excess gives rise to the disadvantage that the electrode may be physically damaged, adversely affecting the sealing efficiency of a battery. The compressive formation process can be performed at room temperature as well as at a high temperature.

As described above, according to the present invention, lithium batteries are manufactured by a formation process under appropriate high-temperature conditions, a formation process at room temperature after storage under appropriate high-temperature conditions, and a compressive formation process. The manufactured lithium batteries exhibit notably improved effects in view of a swelling problem occurring under high-temperature conditions, while minimizing a reduction in capacity.

A method for manufacturing lithium batteries will now be illustrated in greater detail with reference to Examples, but it should be understood that the present invention is not limited thereto.

### Materials Used

In the present invention, LiMn₂O₄ (LM4, Nikki Chemical Co., Ltd., Japan) was used as a positive-electrode active material, a carbon black (Super-P, Showa Denko K.K., Japan) was used as a conductive material for a positive electrode, a mesophase fine carbon (KMFC, Kawasaki Steel Corp.) was used as a negative-electrode active material, and a composition of 1.3M LiPF₆/EC+EMC+DMC+PC (being in a mixture ratio by weight of 41:25:24:10), available from Samsung General Chemicals Co., Ltd., Korea, was used as a liquid electrolyte. Also, polyvinylidenefluoride (PVdF) (KW1300, Kureha Chemical Industry Co., Ltd., Japan) was used as a binder for a positive electrode, and polyvinylidenefluoride (PVdF) (KW1100, Kureha Chemical Industry Co., Ltd., Japan) was used as a binder for a negative electrode. A pouch used had a thickness of 110 μm and a triple-layered structure of chlorinated polypropylene (CPP), an Al foil and nylon laminated sequentially from the innermost layer.

### Fabrication of Battery

In order to manufacture a positive electrode plate, a positive electrode active material, a conductive agent, and a binder were mixed in a binder solution (containing 8 wt % binder in a N-methyl pyrrolidone (NMP) solvent) in a ratio by weight of 93:3:4 using a planetary mixer. The resultant mixture was coated on a positive electrode current collector at a loading capacity of 54.0 mg/cm² using a coater, followed by drying, thereby forming the positive electrode plate. Also, in order to manufacture a negative electrode plate, a negative electrode active material and a binder were mixed in a binder solution (containing 10 wt % binder in an NMP solvent) in a ratio by weight of 92:8. The resultant mixture was coated on a negative electrode current collector at a loading capacity of 17.4 mg/cm², followed by drying, thereby forming the negative electrode plate. The positive and negative electrode coatings were rolled at flux densities of 2.79 mg/cm³ and 1.64 mg/cm³, using a roller, followed by slitting, winding (using a winding device for a prismatic-type battery), inserting, fusing a pouch, injecting an electrolytic solution and finally fusing, thereby completing a battery.

### Aging, Formation, and Evaluation of Standard Capacity and Lifetime

Aging was performed on the manufactured battery by allowing the battery to stand at room temperature for 3 days, followed by formation processes three times, degassing, and, finally, fusing a pouch. Then, the battery was activated by one cycle of standard charging and discharging processes.

During formation, charging was performed with a current of 0.2 C and discharging was performed with a current of 0.5 C During a standard mode in which charging is performed with a current of 0.5 C and discharging is performed with a current of 0.5 C, charging was performed with a current of 0.5 C and discharging was performed with a current of 0.5 C. Also, charging was performed in constant current (CC)/constant voltage (CV) modes with a cut-off time of 3 hours, and discharging was performed in a CC mode with a cut-off voltage of 2.75V.

Lifetime characteristics were evaluated through charge/discharge tests with a 1.0 C condition. The cut-off conditions for charging and discharging were the same as those for formation and standard charging/discharging processes.

### Comparative Example 1

3 cycles of charging (0.5C) and discharging (0.2C) were repeated on a battery having undergone aging after injecting an electrolytic solution into a battery assembly at room temperature. The gas generated during the charging/discharging cycles was removed and thermal fusion was finally performed, thereby completing a battery. After the completed battery was charged with a 0.5 C condition, the standard charge capacity and thickness of the battery were measured. Then, after the standard-charged battery was stored at 85° C. for approximately 4 hours, the thickness of the battery was measured. The remaining capacity of the battery stored under high-temperature conditions was confirmed, and then a standard charging/discharging test was carried out to measure a recovery ratio of the standard capacity.

### Example 1

3 cycles of charging (0.5C) and discharging (0.2C) were repeated at high temperatures, that is, at 35° C., 55° C., and 85° C., respectively on a battery having undergone aging after injecting an electrolytic solution into a battery assembly. The gas generated during the charging/discharging cycles was removed and thermal fusion was finally performed, thereby completing a battery. After the completed battery was charged with a 0.5 C condition, the standard charge capacity and thickness of the battery were measured. Then, after the standard-charged battery was stored at 85° C. for approximately 4 hours, the thickness of the battery was measured. The remaining capacity of the battery stored under high-temperature conditions was confirmed, and then a standard charging/discharging test was carried out to measure a recovery ratio of the standard capacity.

### Example 2

A battery having undergone aging after injecting an electrolytic solution into a battery assembly and then stored at a high temperature of 85° C. for constant periods of time, that is, 30 minutes, 2 hours, and 4 hours, respectively. The gas generated was removed and thermal fusion was primarily performed. 3 cycles of charging (0.5C) and discharging (0.2C) were repeated on a battery having undergone primary thermal fusion at room temperature, thereby completing a battery. After the completed battery was charged with a 0.5 C condition, the standard charge capacity and thickness of the battery were measured. Then, after the standard-charged battery was stored at 85° C. for approximately 4 hours, the thickness of the battery was measured. The remaining capacity of the battery stored under high-temperature conditions was confirmed, and then a standard charging/discharging test was carried out to measure a recovery ratio of the standard capacity.

### Example 3

3 cycles of charging (0.5C) and discharging (0.2C) were repeated on a battery having undergone aging after injecting an electrolytic solution into a battery assembly, at room temperature, while applying thereto external pressures of 10 g/cm², 1000 g/cm², and 5000 g/cm², respectively. The gas generated was removed and thermal fusion was performed, thereby completing a battery. After the completed battery was charged with a 0.5 C condition, the standard charge capacity and thickness of the battery were measured. Then, after the standard-charged battery was stored at 85° C. for approximately 4 hours, the thickness of the battery was measured. The remaining capacity of the battery stored under high-temperature conditions was confirmed, and then a standard charging/discharging test was carried out to measure a recovery ratio of the standard capacity.

The measurement results for Comparative Example and Examples 1-3 are summarized in Tables 1 through 3.

TABLE 1

| | | Example 1 | | |
|---|---|---|---|---|
| | Comparative | Formation at | Formation at | Formation at |
| | Example | 35° C. | 55° C. | 85° C. |
| Swelling ratio | 47.74 | 12.20 | 13.00 | 13.50 |
| (%) at high | | | | |
| temperature | | | | |
| Swelling ratio | 17.36 | 12.27 | 12.50 | 12.00 |
| (%) at room | | | | |
| temperature | | | | |
| Recovery ratio | 100 | 98 | 97 | 98 |
| (%) of standard | | | | |
| capacity | | | | |

TABLE 2

| | | Example 2 | | |
|---|---|---|---|---|
| | Comparative | Storage for | Storage for | Storage for |
| | Example | 30 minutes | 2 hours | 4 hours |
| Swelling ratio | 47.74 | 13.50 | 14.55 | 16.00 |
| (%) at high | | | | |
| temperature | | | | |
| Swelling ratio | 17.36 | 12.30 | 12.40 | 13.00 |
| (%) at room | | | | |
| temperature | | | | |
| Recovery ratio | 100 | 95 | 96 | 95 |
| (%) of standard | | | | |
| capacity | | | | |

TABLE 3

| | | Example 3 | | |
|---|---|---|---|---|
| | Comparative | Formation at | Formation at | Formation at |
| | Example | 10 g/cm² | 1000 g/cm² | 5000 g/cm² |
| Swelling ratio | 47.74 | 25.50 | 24.50 | 24.44 |
| (%) at high | | | | |
| temperature | | | | |
| Swelling ratio | 17.36 | 15.00 | 12.00 | 11.44 |
| (%) at room | | | | |
| temperature | | | | |
| Recovery ratio | 100 | 100 | 100 | 100 |
| (%) of standard | | | | |
| capacity | | | | |

Referring to Tables 1 through 3, the evaluation results showed that though the recovery ratios of the standard capacity of batteries prepared according to the present invention, that is, in cases of high-temperature formation (Example 1), room-temperature formation after high-temperature storage for a constant period of time (Example 2), and room-temperature, compressive formation with external pressure applied (Example 3), were deceased a little compared with those of batteries prepared according to the Comparative Example, that is, in the case of room-temperature formation only (Comparative Example). The swelling ratios, thereof, both at high temperatures and at room temperature were considerably reduced compared with the battery according to the Comparative Example.

As described above, in the method for manufacturing a lithium battery according to the present invention, the problem of swelling often occurring at a high temperature and at room temperature can be notably improved while minimizing deterioration in battery performance, such as accelerated decomposition of electrolyte at a high temperature or a reduction in charge/discharge capacity.

What is claimed is:

1. A method for manufacturing a lithium battery comprising:
forming a battery cell having a predetermined shape by preparing a positive electrode plate and a negative electrode plate by coating a positive electrode current collector and a negative electrode current collector each with a composition containing an active material and a binder, respectively, and disposing the positive and negative electrode plates on both sides of a separator;
inserting the battery cell into a battery case to form a resultant structure; and
subjecting the resultant structure to a high-temperature formation process.

2. The method according to claim 1, wherein the high-temperature formation process is performed at a temperature of approximately 35° C. to approximately 90° C.

3. The method according to claim 1, wherein the high-temperature formation process is performed while applying external pressure to the resultant structure.

4. The method according to claim 1, wherein after the high-temperature formation process, further comprising removing the gas generated in the resultant structure using a degassing process.

5. A method for manufacturing a lithium battery comprising:
forming a battery cell having a predetermined shape by preparing a positive electrode plate and a negative electrode plate by coating a positive electrode current collector and a negative electrode current collector each with a composition containing an active material and a binder, respectively, and disposing the positive and negative electrode plates on both sides of a separator;
inserting the battery cell into a battery case to form a resultant structure;
storing the resultant structure at a high temperature for a predetermined time during a higher temperature storage process; and
subjecting the resultant structure to a room-temperature formation process.

6. The method according to claim 5, wherein the high-temperature storage process is performed at a temperature of approximately 35° C. to approximately 90° C.

7. The method according to claim 5, wherein a time for the high-temperature storage process is in the range of approximately 5 minutes to approximately 4 hours.

8. The method according to claim 5, wherein the room-temperature formation process is performed while applying external pressure to the resultant structure.

9. The method according to claim 5, between the high-temperature storage process and the room-temperature formation process, further comprising removing gas generated in the resultant structure during a degassing process.

10. A method for manufacturing a lithium battery comprising:
forming a battery cell having a predetermined shape by preparing a positive electrode plate and a negative electrode plate by coating a positive electrode current collector and a negative electrode current collector each with a composition containing an active material and a binder, respectively, and disposing the positive and negative electrode plates on both sides of a separator;
inserting the battery cell into a battery case to form a resultant structure; and
subjecting the resultant structure to a compressive formation process while applying external pressure to the resultant structure.

11. The method according to claim 10, wherein the external pressure applied in the compressive formation process is in the range of 10 to 5000 g/cm².

12. The method according to claim 10, wherein the compressive formation process is performed at room temperature.

13. The method according to claim 1, wherein the battery cell includes an electrolyte containing a lithium salt.

14. The method according to claim 2, wherein the battery cell includes an electrolyte containing a lithium salt.

15. The method according to claim 3, wherein the battery cell includes an electrolyte containing a lithium salt.

16. The method according to claim 4, wherein the battery cell includes an electrolyte containing a lithium salt.

17. The method according to claim 5, wherein the battery cell includes an electrolyte containing a lithium salt.

18. The method according to claim 6, wherein the battery cell includes an electrolyte containing a lithium salt.

19. The method according to claim 7, wherein the battery cell includes an electrolyte containing a lithium salt.

20. The method according to claim 8, wherein the battery cell includes an electrolyte containing a lithium salt.

21. The method according to claim 9, wherein the battery cell includes an electrolyte containing a lithium salt.

22. The method according to claim 10, wherein the battery cell includes an electrolyte containing a lithium salt.

23. The method according to claim 11, wherein the battery cell includes an electrolyte containing a lithium salt.

24. The method according to claim 12, wherein the battery cell includes an electrolyte containing a lithium salt.

25. A lithium battery manufactured by the method claimed in claim 1.

26. A lithium battery manufactured by the method claimed in claim 2.

27. A lithium battery manufactured by the method claimed in claim 3.

28. A lithium battery manufactured by the method claimed in claim 4.

29. A lithium battery manufactured by the method claimed in claim 5.

30. A lithium battery manufactured by the method claimed in claim 6.

31. A lithium battery manufactured by the method claimed in claim 7.

32. A lithium battery manufactured by the method claimed in claim 8.

33. A lithium battery manufactured by the method claimed in claim 9.

34. A lithium battery manufactured by the method claimed in claim 10.

35. A lithium battery manufactured by the method claimed in claim 11.

36. A lithium battery manufactured by the method claimed in claim 12.
